(19) United States
(12) Patent Application Publication
(10) Pub. No.: US 2017/0122349 A1
(43) Pub. Date: May 4, 2017

(54) BAGGAGE DOOR

(71) Applicant: LIPPERT COMPONENTS, INC., Elkhart, IN (US)

(72) Inventors: Dallas MARTIN, Sawyer, MI (US); David LEHMAN, Elkhart, IN (US); David WYSONG, Goshen, IN (US)

(21) Appl. No.: 15/376,161

(22) Filed: Dec. 12, 2016

Related U.S. Application Data
(63) Continuation-in-part of application No. 14/932,402, filed on Nov. 4, 2015, now abandoned.
(60) Provisional application No. 62/074,764, filed on Nov. 4, 2014.

(51) Int. Cl. F16B 2/22; B21D 53/36

(52) U.S. Cl. CPC F16B 2/22; B21D 53/36; B60Y 2410/113; B60Y 2410/12; E06B 1/52

(57) ABSTRACT

A door installation clip includes a mounting portion and an engagement portion. The mounting portion is configured for attachment to an exposed edge of an opening in a panel, for example, a sidewall of a vehicle. The engagement portion includes engagement members extending toward the interior of the opening. A frame having an engagement feature may be assembled to the clips and panel by inserting a portion of the frame into the opening such that the engagement feature of the frame engages with an engagement member of the clip.

### CROSS-REFERENCE TO RELATED APPLICATIONS

This application claims benefit as continuation-in-part of U.S. patent application Ser. No. 14/932,402, filed on Nov. 4, 2015, which claims benefit of U.S. Provisional Patent Application No. 62/074,764, filed on Nov. 4, 2014, and incorporates by reference the disclosures thereof in their entireties.

### BACKGROUND OF THE DISCLOSURE

Baggage doors for recreational vehicles, buses, and the like typically are provided as a door panel pre-hung in a frame that may be installed in and secured to an opening in a panel, for example, a sidewall, of the vehicle. The frame typically includes a web configured to be inserted into the opening, and a flange configured to abut an outer surface of the sidewall (or a seal disposed between the flange and the sidewall) when the web is fully inserted into or through the opening. The frame may be secured to the vehicle by driving screws through the web or apertures therein and into an edge of the sidewall between the outer surface and a corresponding inner surface thereof.

### BRIEF DESCRIPTION OF THE DRAWINGS

FIG. 1 is a perspective view of a panel having an opening therein and a plurality of illustrative door installation clips according to a first embodiment of the present disclosure fastened to an edge of the opening;

FIG. 2 is a perspective view of a portion of the panel and opening therein of FIG. 1 and a plurality of door installation clips according to a first embodiment of the present disclosure fastened to an edge of the opening;

FIG. 3 is a perspective view of a portion of an illustrative door frame installed in the opening of the panel of FIG. 1 with a web of the door frame engaged with one of the door installation clips of FIG. 1;

FIG. 3A is an end view of the assembly of FIG. 3;

FIG. 4 is a side elevation view of an illustrative door installation clip according to a first embodiment of the present disclosure;

FIG. 5 is a front elevation view of the illustrative door installation clip of FIG. 4;

FIG. 6 is a rear perspective view of the door frame of FIG. 3 installed in an opening in a panel and engaged with an illustrative door installation clip according to a first embodiment of the present disclosure;

FIG. 7 is a front perspective view of a the door frame of FIG. 3 partially installed in an opening in a panel;

FIG. 8 is a front perspective view of the door frame of FIG. 3 partially installed in an opening in a panel;

FIG. 9 is a rear perspective view of a panel having an opening therein, a plurality of illustrative door clips according to a second embodiment of the disclosure attached to a surface of the panel adjacent the opening, and a door frame engaged with the door installation clips;

FIG. 10 is a rear elevation view of the panel, door frame, and door installation clips of FIG. 9;

FIG. 11 is a first cross sectional view of the panel, door frame, and one of the door installation clips of FIG. 9;

FIG. 12 is a second cross sectional view of the panel, door frame, and one of the door installation clips of FIG. 9;

FIG. 13 is a cross-sectional end view of the panel, door frame, and some of the door installation clips of FIG. 9;

FIG. 14 is a perspective view of one of the door installation clips of FIG. 9;

FIG. 15 is a side elevation view of one of the door installation clips of FIG. 9;

FIG. 16 is a cross-sectional side elevation view of one of the door installation clips of FIG. 9;

FIG. 17 is a front elevation view of one of the door installation clips of FIG. 9;

FIG. 18 is a cross-sectional side elevation view of a portion of the door frame of FIG. 9;

FIG. 19 is a perspective view of a door installation clip according to the present disclosure with a removal tool inserted into a recess thereof;

FIG. 20 is a perspective view of a door installation clip according to the present disclosure;

FIG. 21 is an end elevation view of the door installation clip of FIG. 20;

FIG. 22 is a bottom elevation view of the door installation clip of FIG. 20;

FIG. 23 is a top elevation view of the door installation clip of FIG. 20; and

FIG. 24 is a view of a blank from which the door installation clip of FIG. 20 may be formed.

### DETAILED DESCRIPTION OF THE DRAWINGS

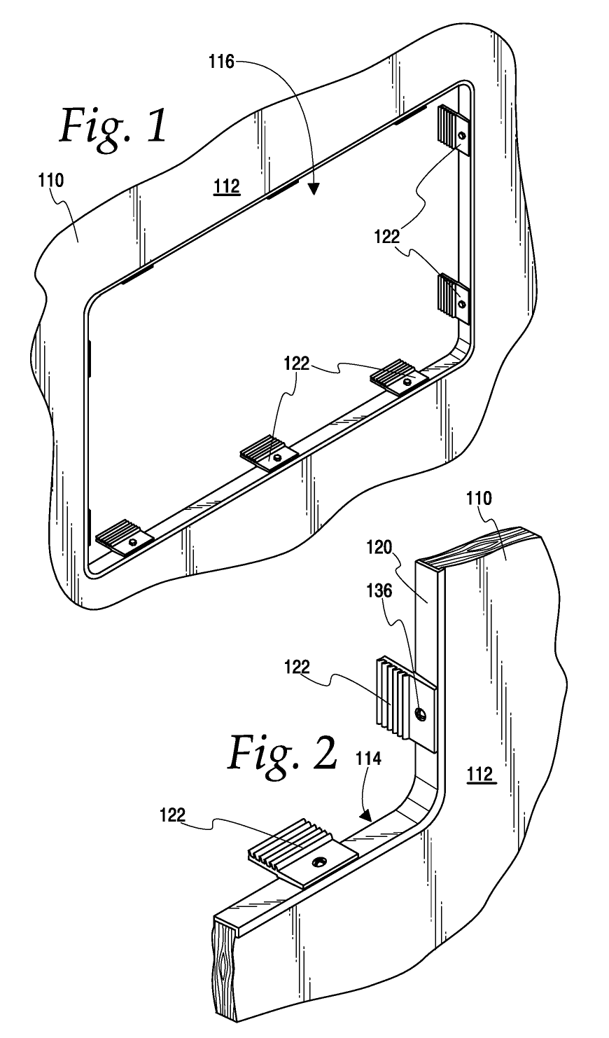

FIGS. 1-3 and 6-8 show a panel 110 that could be embodied as a side wall of a vehicle, for example, a bus or recreational vehicle. The panel 110 has a first or outer or front surface 112 and a second or inner or rear surface 114. The panel 110 defines an opening or aperture 116 extending from the first surface 112 to the second surface 114 of the panel 110. An edge 120 extends from the first surface 112 to the second surface 114 of the panel 110.

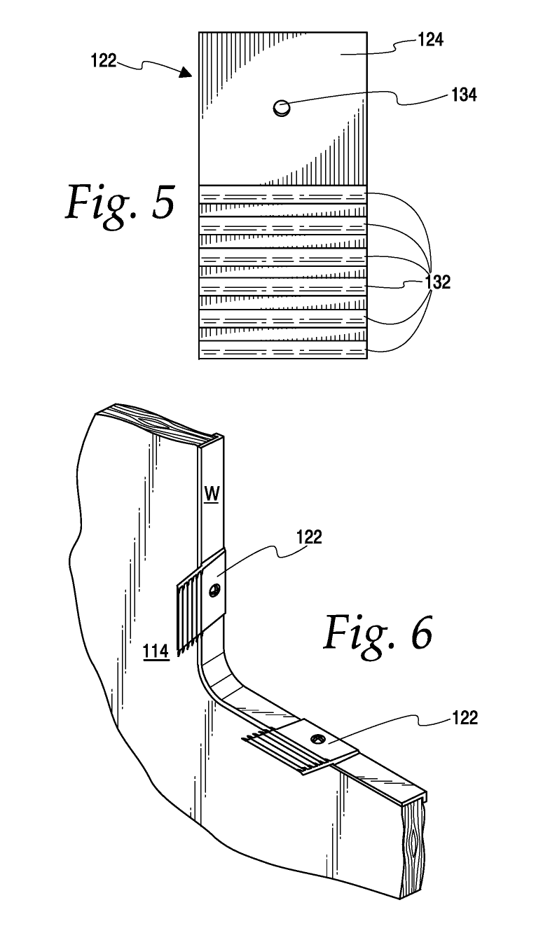

FIGS. 4 and 5 show an illustrative door installation clip 122. The door installation clip 122 includes a base portion 124 and an engagement portion 126. The base portion 124 is wedge-shaped or tapered, and it defines a mounting surface 128 and an opposite surface 130. The engagement portion 124 includes a plurality of engagement members 132 in the form of hooks or barbs extending from a surface of the engagement portion 126 corresponding to the opposite surface 130. The base portion 124 defines an aperture 134 configured to receive a screw 136 or other mechanical fastener. A land 150 extends inwardly from the mounting surface 128 proximate an interface between the base portion 124 and the engagement portion 126.

FIGS. 1-3 best show a plurality of door installation clips 122 attached to the edge 120 of the panel 110 using screws 136 inserted through the aperture 134 of the door installation clip and driven into the edge of the panel such that the engagement members face an interior of the opening 116.

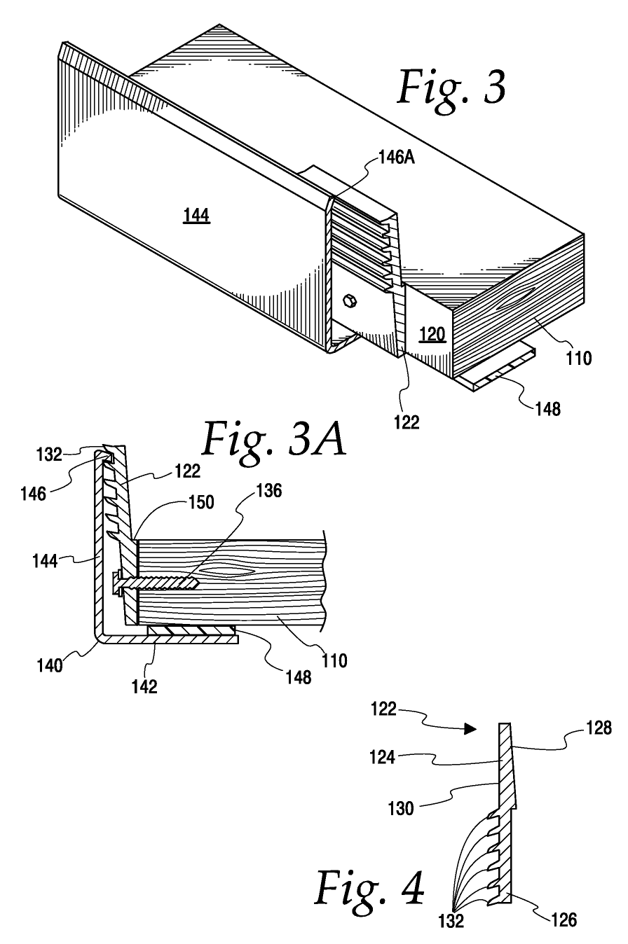

FIGS. 3-3A show in cross-section an illustrative door frame 140 inserted into the opening 116 in the panel 110 and secured to one of the door installation clips 122. The door frame 140 includes a flange 142 and web 144 extending generally perpendicularly from the flange. An engagement feature in the form of a hook 146 at the free end of the web 144 is engaged with an engagement member 132 of the door installation clip 122, as shown in FIG. 3A. Alternatively, the engagement feature could take the form of a rolled over lip or bead 146A, as shown in FIG. 3. (An engagement feature 146 in the form of a hook may provide for more secure engagement of the door frame 140 with the clip 122, whereas an engagement feature in the form of a bead or lip may allow for easier disassembly of the door frame 140 from the clip 122.) The exposed surface 30 and the corresponding surface from which the engagement members 32 of the door installation clip 124 extend taper inwardly, toward the interior of the opening 116. A gasket or seal 148 is disposed between the flange 142 and the outer surface 112 of the panel 110.

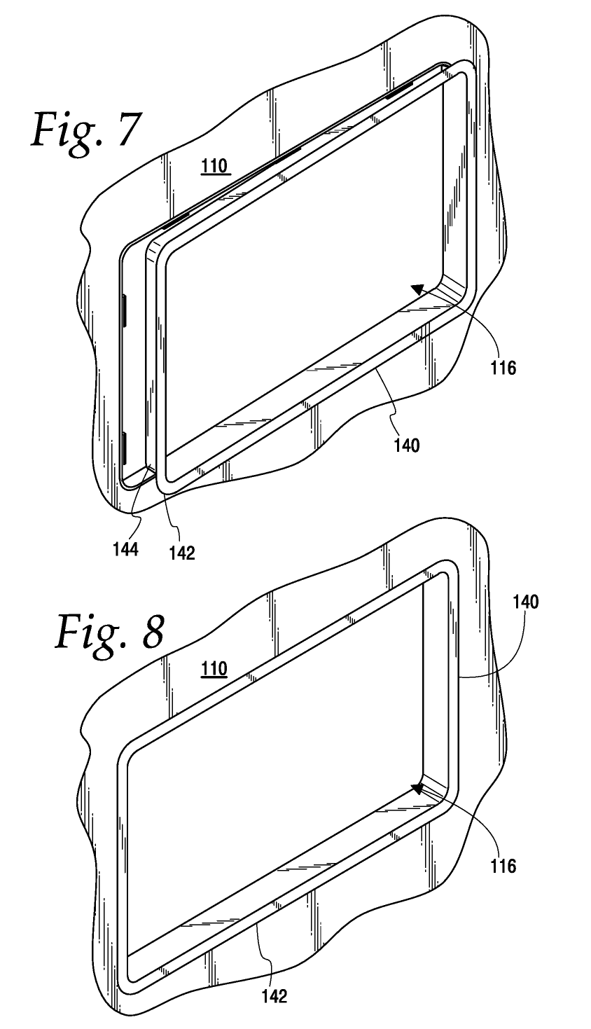

FIG. 7 shows the door frame 140 partially inserted into the opening 116 in the panel 110. FIG. 8 shows the door frame 140 fully inserted into the opening 116 in the panel 110.

Typically, a door panel (not shown) would be hingedly attached to a portion of the frame 140, for example, to the web 144 or the flange 142 of the frame 140. Alternatively, the door panel could be removably attachable to the frame 140.

The door installation clip 122 could be attached to the edge 120 of the panel 110 by placing the mounting surface 128 of the clip against the edge 120, inserting the screw 136 through the opening 134 in the clip, and driving the screw into the edge of panel. The land 150 could be used as an aid to aligning the clip 122 with the panel 110 in a desired orientation. In a typical application, a plurality of clips 122 would be installed to the edge 120.

The door frame 140 could be attached to the clips 122 by inserting the web 144 of the frame into the opening 116. As the web is inserted into the opening 116, the lip 146 engages with the engagement members 132 of the clip 122. With the clip 122 installed to the edge 120 as shown, the engagement members 132 are oriented such that the lip 146 can readily slide across the engagement members in one direction (the insertion direction), but not in the other direction (the removal direction). In some embodiments, the door frame 140 could be removed from the opening 116 by deflecting the free end of the clip 122 away from the opening, thus deflecting the engagement members 132 away from the lip 146.

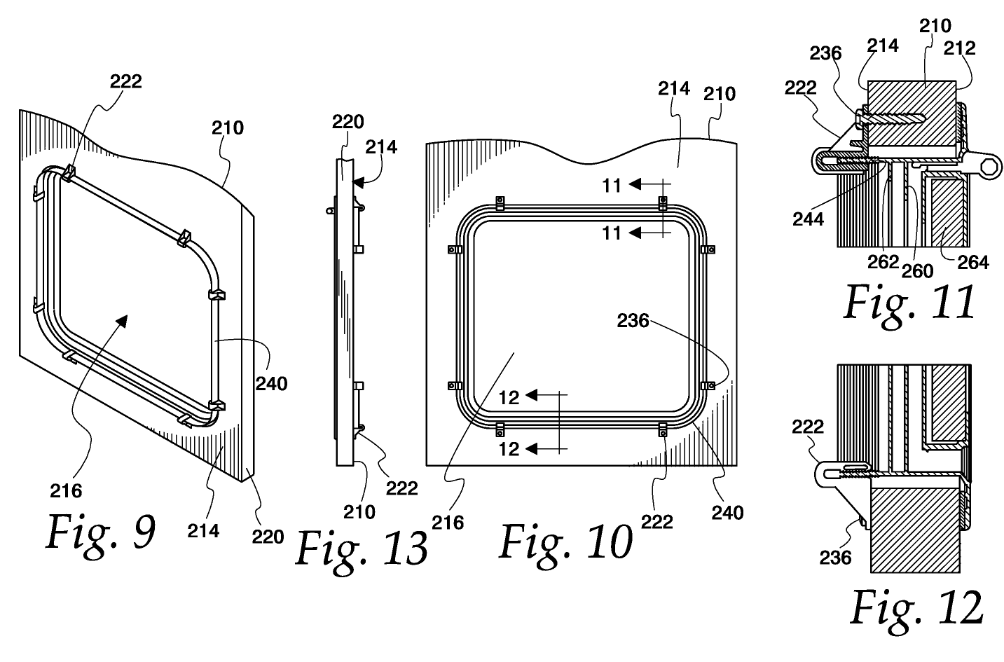

FIGS. 9-13 show another panel 210 having a first or outer or front surface 212 and a second or inner or rear surface 214. The panel 210 defines therein an opening 216 extending from the first surface 212 to the second surface 214. A plurality of illustrative door installation clips 222 is attached to the second surface 214 of the panel, and an illustrative door frame 240 is installed within the opening 216 and attached to the door installation clips.

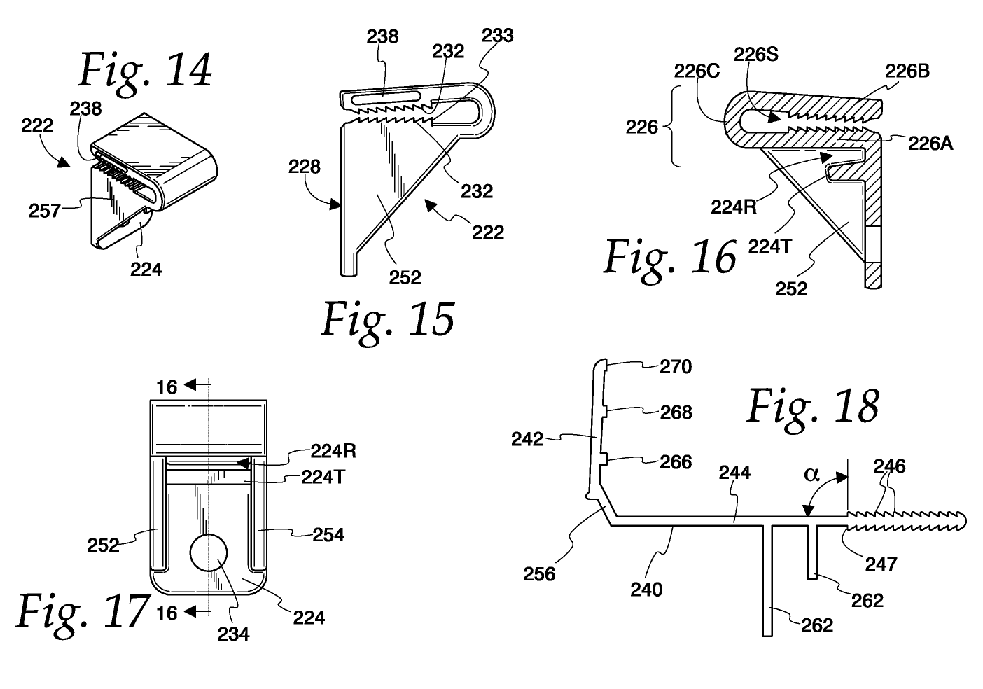

As best shown in FIGS. 14-17, each door installation clip 222 includes a base 224 having a generally planar rear or mounting surface 228 configured for abutment with the second surface 214 of the panel 210. The base 224 defines an aperture 234 for receiving a screw 236 or other mechanical fastener that might be used to fasten the clip 222 to the panel 210. An engagement portion 226 extends generally perpendicular from the base 224 in a direction opposite the rear surface 228 of the clip 222. The engagement portion 226 of the clip 222 is generally U-shaped, having a first leg 226A extending from the base 224 and a second leg 226B generally parallel to the first leg and joined to the first leg by a connector 226C. The first leg 226A, the second leg 226B, and the connector 226C cooperate to define an interior region or slot 226S. Although the first leg 226A and the second leg 226B are generally parallel to each other, they may be out of parallel by a predetermined amount, for example, by about 4 degrees or more or less, such that the free ends of the first and second legs are closer together than the ends of the first and second legs joined to the connector 226C.

The opposing inner surfaces of each the first and second legs 226A, 226B define a plurality of engagement members 232 in the form of hooks or barbs extending inwardly from the inner surfaces of the first and second legs. The engagement members 232 are configured to cooperate with mating engagement members of a flange of the door frame 240, as will be discussed further below. The engagement members 232 are configured to allow the mating engagement members to be received therein and to secure the mating engagement members once received therein. The engagement members 232 could, but need not, extend the entire depth of the slot 226S. As shown, the engagement members 232 extend over about two-thirds of the depth of the slot 226S or somewhat more or less.

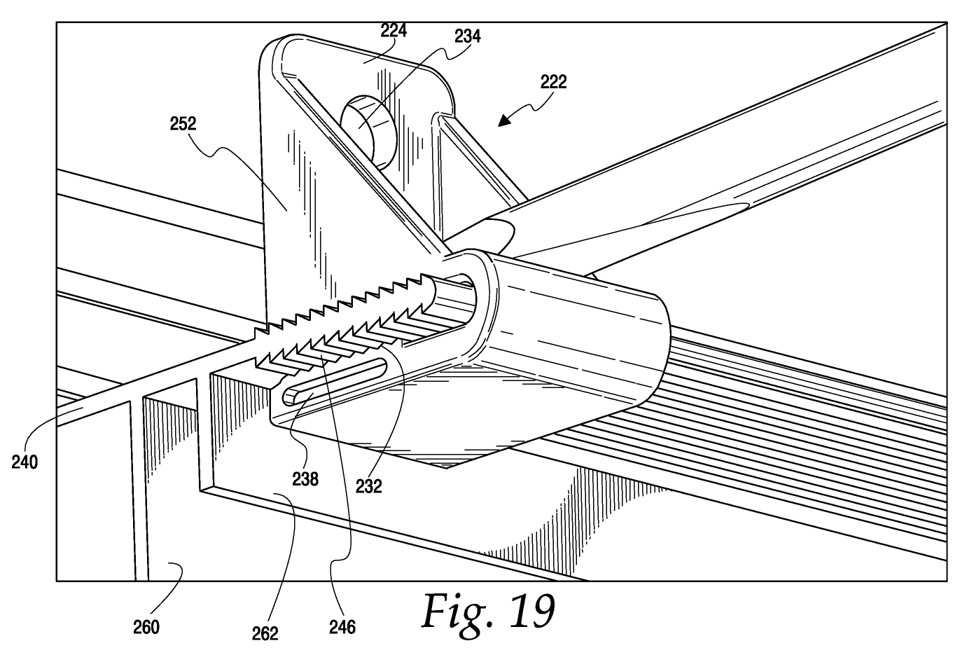

As best shown in FIGS. 16 and 17, the base 224 may include a forward-extending tab 224T that cooperates with the first leg 226A to define a recess 224R. The recess 224R may be configured to selectively receive the blade of a flat screwdriver or a similar tool, as shown in FIG. 19. As best shown in FIGS. 14 and 15, the outer edge surfaces of the second leg 226B define respective recesses or grooves 238 configured to receive the blade of a flat screwdriver or other tool (not shown). Such tools could be used to bias the first and second legs 226A, 226B of the engagement portion 26 apart from each other to enable disengagement of the engagement members 232 of the clip 22 from complementary engagement members of the door frame 240, as will be discussed further below.

A first web 252 may extend between the base 224 and the first leg 226A proximate first outer edges thereof, and a second web 254 may extend between the base and the first leg proximate second outer edges thereof opposite the first outer edges thereof. The first and second webs 252, 254 are shown as generally triangular but could have other shapes.

The door installation clip 222 may be made of any suitable material that is sufficiently flexible to allow for the first and second legs 226A, 226B to spread apart to receive the engagement members of the frame flange and sufficiently resilient to return toward their normal position to secure the frame flange thereto. In an embodiment, the clip 222 may be made of Delrin® plastic or another material having suitable flexibility and resiliency. For example, the clip 222 may be made of a suitable metal or metal-reinforced plastic.

FIG. 18 is a cross-sectional view of the door frame 240. The door frame 240 may include a first leg 242 and a second leg 244 generally perpendicular to the first leg. As shown, an optional connector 256 is disposed intermediate the first leg 242 and the second leg 244. The connector 258 is shown at about a 30 degree angle to the adjacent end of the first leg and at about a 60 degree angle to the adjacent end of the second leg 244.

The first leg is generally linear but may have a slight radius of curvature, thereby defining a convexity oriented in the direction away from which the second leg 244 extends from the first leg 242. First, second, and third projections 266, 268, 270 extend a short distance generally perpendicular from the first leg 242. Each of the first, second, and third projections 266, 268, 270 terminates in a generally planar surface configured for engagement with the first surface 212 of the panel 210 or an intervening gasket or seal 248 when the door frame 240 is installed thereto.

The second leg 244 is generally linear. A free end of the second leg 244 may define a plurality of engagement features 246 extending therefrom. The engagement features 246 are configured in a manner complementary to the engagement features 232 on the door installation clip 222. An engagement surface 247 may be at an angle α from a longitudinal axis of the second leg 244. The angle α typically would be 90 degrees or more. In an embodiment, the angle α a may be 87 degrees. (Engagement surfaces 233 of the engagement features 232 of the clip 222 may be angled in a complementary manner relative to the first and second legs 226A, 226B of the engagement portion 226 of the clip 222 in order to effect secure engagement of the respective engagement features 232, 246 with each other.) First and second flanges 260, 262 may extend from the second leg 244, generally perpendicular thereto. The first flange 260 may act as a stop for a door panel 264 installed in the door frame 240. A seal (not shown) may be disposed on the outer face of the first flange 260 to provide a seal between the first flange and the door when the door is closed against the first flange. The second flange 262 may be used as an attachment point for a latch to secure the door panel 264 to the door frame 240 when the door is closed.

The door frame 240 may be attached to the panel 210 proximate the opening 216 therein by attaching a plurality of door installation clips 222 to the rear surface 214 of the panel such the slot 226S of the engagement portion 226 faces and is generally perpendicular to the opening. The free end of the second leg 244 the door frame 240 may be inserted into the slot 226S of the engagement portion 226 of each of the door installation clips 222 so that the engagement members 246 of the second leg lockingly engage with the engagement members 232 of the clips 222. An intervening gasket or seal 248 may be disposed between the panel and the door frame 240. The door frame 240 could be removed from the clips 222 by biasing the first and second legs 226A, 226B of the clips apart from each other using tools engaged with the recess 224R and the grooves 238, as discussed above, and withdrawing the second leg 244 of the door frame from the respective slots 226S of the clips.

As best shown in FIG. 11, a door 264 may be hingedly attached to a first side of the door frame 240, for example, an upper side of the door frame, as part installed in the panel. A latch (not shown) may be associated with a lower side of the door 264 and the door frame 240.

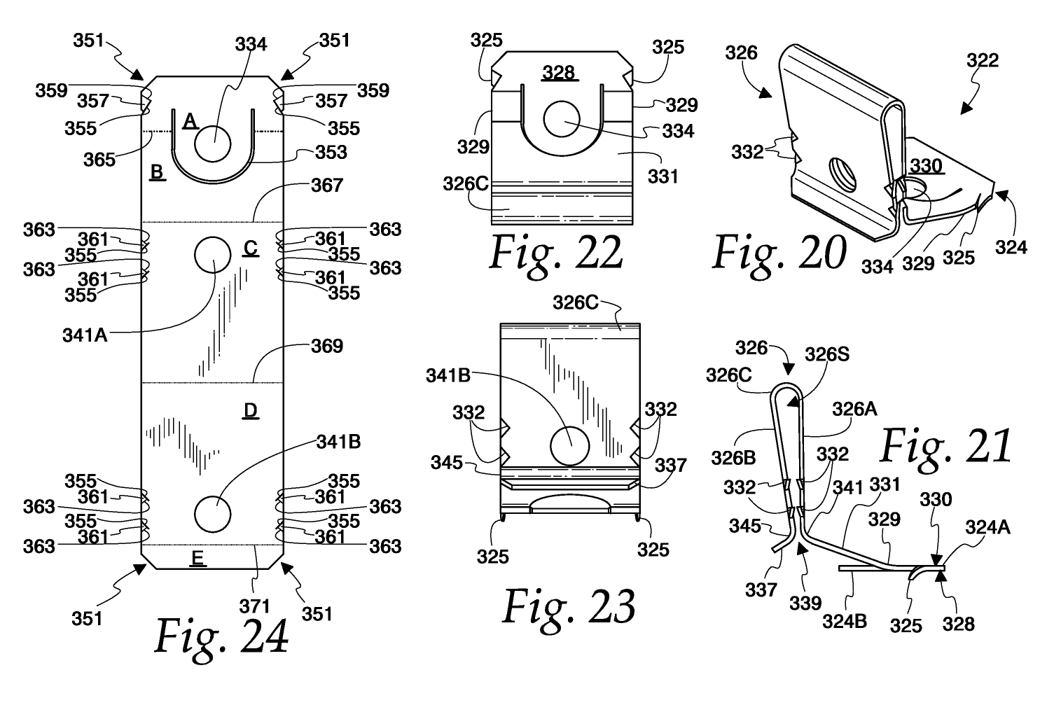

FIGS. 20-24 show another embodiment of a door installation clip 322 according to the present disclosure. The door installation clip 322 includes a generally planar base portion 324 and an engagement portion 326.

The base portion 324 defines a mounting surface 328 and an opposite surface 330. The base portion 324 includes an elongated, generally rectangular area 324A having a relatively long dimension and relatively short dimension, and a U-shaped area 324B co-planar with and extending from the rectangular portion. The U-shaped area is generally centered between ends of the rectangular area defined by the longer dimension thereof. The U-shaped area 324B defines an aperture 334 configured to receive a fastener (not shown), for example, a rivet, screw, nail, or other mechanical fastener. The rectangular area 324A is formed to define first and second teeth 325 extending out of the plane defined by the base portion 324 in a direction away from the opposite surface 330.

The engagement portion 326 includes a first leg 326A, a second leg 326B and a generally U-shaped connector 326C connected between the first leg and the second leg. As such, the engagement portion 326 has a generally U-shaped cross-section. The first leg 326A and the second leg 326B are shown as planar, but they could have other forms. The first leg 326A, second leg 326B, and connector 326C cooperate to define an interior region or slot 326S of the engagement portion 326. The first leg 326A and the second leg 326B cooperate to define an elongated opening 339 opposite the connector 326C configured receive a mating structure, as will be discussed further below. A flange 337 extends from the free end of the second leg 326B via an intervening bend section 345. The engagement portion 326 (and other portions) of the clip 322 may be made of spring steel or another flexible and resilient material enabling the ends of the first and second legs 326A, 326B opposite the connector 326C to be spread apart sufficiently to receive and securely engage the mating structure.

A plurality of engagement members in the form of barbs 332 extend from each side of each of the first leg 326A and the second leg 326B into the slot 326S. The engagement members 332 are configured to cooperate with a mating structure, for example, a mating flange of the door frame 240 including mating engagement 246, as discussed further above and shown in FIGS. 18 and 19. In an embodiment, the engagement features 246 could be omitted from the mating flange, and the engagement features 332 of the clip 322 could engage directly with a surface of the mating flange. In any event, the engagement members 332 are configured to allow the flange to be readily inserted into the slot 326S from the opening 339 toward the connector 326C, but to resist removal of the flange from the slot 326S in the opposite direction.

Each of the first leg 326A and the second leg 326B may define an aperture 341A, 341B therein.

The base portion 324 is connected to the engagement portion 326 via a transition portion connected between the rectangular area 324A of the base portion 324 and the end of the first leg 326A of the engagement portion 326 opposite the connector 326C. The transition portion includes first and second bend regions 329, each extending from the rectangular area 324A of the base portion 324 on respective opposite sides of the U-shaped section 324B. A generally planar extension region 331 extends from the first and second bend regions 329. A further bend section 341 extends from the extension region 331 to the end of the first leg 326A of the engagement portion 326 opposite the connector 326C. The extension region 331 is shown as generally planar but it could have other forms.

The bend sections 341, 345, alone or in combination with one or both of the flange 337 and the extension region 331, cooperate to define a funnel-shaped entry or approach to the opening 339. The funnel-shaped entry or approach to the opening 339 facilitates insertion of a mating component into the slot 326S of the engagement portion 326.

In use, the door clip 322 may be attached to a panel, for example, a panel similar to the panel 210 discussed above, by abutting the mounting surface 328 of the base portion 324 against a surface of the panel in a desired orientation, and fastening the door clip to the panel using a fastener (not shown) disposed through the aperture 334. The teeth 325 are configured to “bite” into the panel surface when the clip 322 is attached to thereto, thereby preventing rotation of the clip with respect to the panel, even when the clip is attached to the panel using only a single fastener. A mating structure, for example, a flange of a door frame similar to the door frame 240 discussed above, may be inserted into the slot 326S of the engagement portion 326 in a direction from the opening 339 toward the connector 326C. The engagement members 332 may “bite” into the mating structure or interact with engagement structure (for example, structure similar to engagement members 246) of the mating structure to thereby engage the mating structure so that the mating structure is not readily removable from the opening 335. In an embodiment, a fastener may be installed through the apertures 341A, 341B of the clip 322 and the mating structure to further secure the clip to the mating structure.

Notwithstanding, the free end of the second leg 326B of the engagement portion 326 may be pried away from the mating structure using a tool inserted through the aperture 341B. Alternatively, the free end of the second leg 326B of the engagement portion 326 may be pried away from the mating structure using a tool inserted into the slot 326S from a side thereof to facilitate removal of the mating structure from the slot.

The door installation clip 322 may be formed from a blank of spring steel or another suitable material. For example, a blank may be punched, sheared, lanced, and/or otherwise formed to yield the generally rectangular structure shown in FIG. 24. That structure includes clipped corners 351 and defines a U-shaped groove 353, apertures 334, 341A, 341B in regions A, C, and D of the blank, respectively, and cuts 355 extending inwardly into regions A, C, and D of the blank from respective side edges of the blank. In an embodiment, the corners may be clipped and the U-shaped groove 353 and apertures 334, 341A, 341B may be formed by punching, and the cuts 355 may be formed by lancing.

Portions 357 of the structure shown in FIG. 24 may be bent about fold lines 359 to form the teeth 325. Similarly, portions 361 of the structure shown in FIG. 24 may be bent about fold lines 363 to form the engagement members 332.

Adjacent regions A, B of the structure shown in FIG. 24 may be bent about fold line 365. Adjacent regions B, C of the structure shown in FIG. 24 may be bent about fold line 367. Adjacent regions C, D of the structure shown in FIG. 24 may be bent about fold line 369. Adjacent regions D, E of the structure shown in FIG. 24 may be bent about fold line 371. The foregoing steps of bending may involve bending the respective regions about respective dies centered on the respective fold lines, with the radius of each of the respective die selected to yield a desired radius of curvature about the respective fold line.

With the clip 322 so formed, opposing ones of engagement members 332 furthest from the connector 326C may be proximate or in contact with each other. The first leg 326A and second leg 326B and, consequently, the engagement members 332, may be spread apart from each other in response to insertion of a mating structure into the slot 339. The engagement portion 326 is sufficiently resilient so that the engagement members 322 grip or otherwise engage with the inserted mating structure to resist removal of the mating structure from the slot 339.

The embodiments disclose herein are illustrative and may be modified without departure from the appended claims.

1. A method of making a clip, comprising the steps of:
providing a blank;
bending a first region of the blank with respect to a second region of the blank;
bending the second region of the blank with respect to a third region of the blank;
bending the third region of the blank with respect to a fourth region of the blank;
bending the fourth region of the blank with respect to a fifth region of the blank;
forming a U-shaped groove extending from the first region of the blank to the second region of the blank;
forming a first aperture into the first region of the blank;
forming at least one first cut into the first region of the blank from a side edge of the blank;
forming at least one second cut into the third region of the blank from a side edge of the blank;
forming at least one third cut into the fourth region of the blank from a side edge of the blank;
bending a portion of the first region of the blank with respect to another portion of the first region of the blank along a first fold line intersecting a first one of the at least one first cut;
bending a portion of the third region of the blank with respect to another portion of the third region of the blank along a second fold line intersecting a first one of the at least one second cut; and
bending a portion of the fourth region of the blank with respect to another portion of the fourth region of the blank along a third fold line intersecting a first one of the at least one third cut.

2. The method of claim 1 wherein at least one of the steps of bending one of the first through fifth regions with respect to another of the first through fifth regions involves bending about a die.

3. The method of claim 2 wherein the die has a radius corresponding to a desired radius of curvature of a bend yielded by the corresponding step of bending.

4. The method of claim 1 wherein the step of bending the third region with respect to the fourth region yields a first leg, a second leg, and a connector between the first leg and the second leg, wherein the first leg, the second leg, and the connector cooperate to define a slot and an opening opposite the connector.

5. The method of claim 4 wherein the step of bending the portion of the third region with respect to the another portion of the third region and the step of bending the portion of the fourth region with respect to the another portion of the fourth region yield first and second engagement members extending into the slot.

6. The method of claim 5 wherein the first engagement member is opposite the second engagement member.

7. The method of claim 6 wherein the first engagement member is in selective contact with the second engagement member.

8. The method of claim 1, wherein the step of bending the portion of the first region of the blank with respect to the another portion of the first region of the blank yields a tooth extending from a plane defined by the another portion of the first region.

9. The method of claim 1, wherein the blank is made of a flexible and resilient material.

10. The method of claim 9, wherein the blank is made of spring steel.

11. The method of claim 1 wherein the step of bending the portion of the first region with respect to the another portion of the first region yields a tooth extending in a direction away from the second and third regions.

12. A clip made according to the method of claim 11.

13. The method of claim 5 wherein the step of bending the portion of the first region with respect to the another portion of the first region yields a tooth extending in a direction away from the second and third regions.

14. A clip made according to the method of claim 13.

15. A method of using a clip according to claim 14 comprising the steps of:
attaching the clip to a panel using a fastener extending through the first aperture whereby the tooth grippingly engages the panel;
inserting a mating structure into the slot through the opening and toward the connector, whereby the engagement members grippingly engage the mating structure.

16. The method of claim 15 wherein the mating structure includes at least one engagement member configured to engage with the engagement members of the clip.

17. The method of claim 5 further comprising the steps of:
forming a second aperture into the third region of the blank; and
forming a third aperture into the fourth region of the blank.

18. A method of using a clip made according to the method of claim 17 comprising the steps of:
attaching the clip to a panel using a fastener extending through the first aperture whereby the tooth grippingly engages the panel;
inserting a mating structure into the slot through the opening and toward the connector, whereby the engagement members grippingly engage the mating structure;
inserting a second fastener through the second aperture, the mating structure, and the third aperture.

19. A method of making a clip, comprising the steps of:
providing a blank;
bending a first region of the blank with respect to a second region of the blank;
bending the second region of the blank with respect to a third region of the blank;
bending the third region of the blank with respect to a fourth region of the blank;
bending the fourth region of the blank with respect to a fifth region of the blank;
forming a U-shaped groove extending from the first region of the blank to the second region of the blank.

20. The method of claim 19 further comprising the steps of:
forming at least one first cut into the first region of the blank from a side edge of the blank; and
bending a portion of the first region of the blank with respect to another portion of the first region of the blank along a first fold line intersecting a first one of the at least one first cut, thereby yielding a tooth extending in a direction away from the second and third regions.

21. The method of claim 20 further comprising the steps of:
forming at least one second cut into the third region of the blank from a side edge of the blank; and
bending a portion of the third region of the blank with respect to another portion of the third region of the blank along a second fold line intersecting a first one of the at least one second cut;
and/or the steps of:
forming at least one third cut into the fourth region of the blank from a side edge of the blank; and
bending a portion of the fourth region of the blank with respect to another portion of the fourth region of the blank along a third fold line intersecting a first one of the at least one third cut.
